(19) United States
(12) Patent Application Publication
(10) Pub. No.: US 2026/0094078 A1
(43) Pub. Date: Apr. 2, 2026

(54) AI-DRIVEN REQUISITION OPTIMIZATION TO STREAMLINE PROCUREMENT AND RESOURCE REALLOCATION

(71) Applicant: SiteWhirks, LLC, Warrenton, VA (US)

(72) Inventor: Matthew Carson, Warrenton, VA (US)

(21) Appl. No.: 18/903,393

(22) Filed: Oct. 1, 2024

(51) Int. Cl. G06Q 10/0631; G06Q 30/0601

(52) U.S. Cl. CPC G06Q 10/0631; G06Q 30/0631

(57) ABSTRACT

Disclosed are a method, apparatus, and system of artificial intelligence-driven requisition optimization to streamline procurement and resource reallocation. In one embodiment, a method includes identifying an item associated with a requisition request of a user using a processor and a memory. The method determines whether the user is permitted to request the item based on a set of permissions assigned to the user. The method automatically suggests a preferred substitute to the item based on an artificial intelligence optimization engine that prioritizes a criteria including any of an availability, a price, a vendor, and/or a recommendation score.

### FIELD OF TECHNOLOGY

This disclosure relates generally to a commerce system, and more particularly to a method of artificial intelligence-driven requisition optimization to streamline procurement and resource reallocation.

### BACKGROUND

In large enterprises, the procurement process may be plagued by inefficiencies that can cause significant financial and/or operational setbacks. Navigating through complex procurement systems and adhering to corporate policies or approved vendor lists can be overwhelming for employees. This complexity may lead to non-compliant purchases, with employees either bypassing approved vendors or choosing items that don't meet organizational standards, and may cause increased costs and/or potential contractual breaches.

Employees may not have access to the most cost-effective options or lack the expertise to identify them. This can cause purchasing items at higher prices than necessary, leading to inflated procurement costs. Without an intelligent system to compare prices, quality, and/or vendor agreements, organizations may miss out on opportunities for significant savings.

After a purchase is made, there may be no systematic way to collect and/or analyze feedback on the quality and usability of the products. This disconnect can mean that valuable information, such as user satisfaction and/or product performance, is not captured or utilized. Consequently, poor-quality items may continue to be purchased, negatively impacting employee productivity and/or satisfaction.

The approval process for requisitions can be manual and/or cumbersome, with requests being routed through multiple layers of management without a clear framework. This may lead to delays, lost requests, and/or frustration among employees. Managers may also lack the contextual information needed to make informed decisions quickly, causing further delays and/or inefficiencies.

Once items are purchased, they may not be fully utilized. Employees may stop using them, or the assets may not fit their needs as initially expected. There may not be a mechanism in place to track these assets, assess their utilization, and/or reallocate them efficiently within the organization, resulting in wasted resources and additional unnecessary purchases.

There may also be a lack of alignment between purchased items and/or their impact on business productivity. Items that are not fit-for-purpose or not aligned with job roles can hinder rather than enhance performance. This misalignment can not only reduce the return on investment for these assets but also can demoralize employees who feel their needs are not being properly met. The entire process of procurement, from request submission to approval and/or eventual purchase, may consume valuable time and resources. Employees and/or managers may be burdened with administrative tasks, which detract from their core responsibilities and/or reduce overall productivity. These challenges can create a cycle of inefficiency, increased costs, and/or reduced employee satisfaction.

### SUMMARY

Disclosed are a method, a system, and/or an apparatus of artificial intelligence-driven requisition optimization to streamline procurement and resource reallocation.

In one aspect, a method includes identifying an item associated with a requisition request of a user using a processor and a memory. The method determines whether the user is permitted to request the item based on a set of permissions assigned to the user. The method automatically suggests a preferred substitute to the item based on an artificial intelligence optimization engine that prioritizes a criteria including any of an availability, a price, a vendor, and/or a recommendation score.

The method may include processing a natural language string of the requisition request using a large language model. The method includes determining the item based on an inference generated by a fine tuned version of the large language model that may be optimized based on requisition phraseology when the natural language string is automatically provided in a context window analyzed by the fine tuned version of the large language model. The method may determine the item and/or the preferred substitute is described as available in an internal asset reallocation server. The method may automatically suggest to the user to select the item and/or the preferred substitute that is available in the internal asset reallocation server.

The method may automatically generate a recommendation to a manager to approve the requisition request using the artificial intelligence optimization engine. The method may include automatically procuring the item and/or the preferred substitute for the user when the manager associated with the user approves the requisition request. The method may include requesting that the user provide a satisfaction score to the item and/or the preferred substitute when the user receives the item and/or the preferred substitute. The method may further include occasionally querying the user to determine if the item and/or the preferred substitute provided to the user may still desire and/or may be placed in an available item in the internal asset reallocation server.

In another aspect, a system includes identifying an item that is associated with a requisition request of a user using a processor and a memory, determining whether the user is permitted to request the item based on a set of permissions assigned to the user, processing a natural language string of the requisition request using a large language model, and determining the item based on an inference generated by a fine tuned version of the large language model that is optimized based on requisition phraseology when the natural language string is automatically provided in a context window analyzed by the fine tuned version of the large language model.

The system may automatically suggest a preferred substitute to the item based on an artificial intelligence optimization engine that prioritizes a criteria including any of an availability, a price, a vendor, and/or a recommendation score. The system may determine that the item and/or the preferred substitute is described as available in an internal asset reallocation server. The system may automatically suggest to the user to select the item and/or the preferred substitute that is available in the internal asset reallocation server. The system may automatically generate a recommendation to a manager to approve the requisition request using the artificial intelligence optimization engine. The system may automatically procure the item and/or the preferred substitute for the user when the manager associated with the user approves the requisition request. The system may request that the user provide a satisfaction score to the item and/or the preferred substitute when the user receives the item and/or the preferred substitute. The system may occasionally query the user to determine if the item and/or the preferred substitute provided to the user is still desired and/or may be placed in an available item in the internal asset reallocation server.

In yet another aspect, an automated ordering method includes enabling a user to describe their needs in natural language via a communication medium including an audio input, a video input, and/or a syntax input. The method includes, selecting a product and/or a service from an organized database based on an inference generated by a fine tuned version of a large language model that is optimized based on requisition phraseology when the description of needs in natural language is automatically provided in a context window analyzed by the fine tuned version of the large language model. The method further includes generating an automated quote for the product and/or the service. In addition, the method includes approving the automated quote and/or sending an order for the product and/or the service to a vendor.

The automated ordering method may provide direct links to recommend the product and/or the service based on cost, quality, compliance with corporate policies, and/or employee feedback. The method may include prioritizing the product and/or service that delivers the best value.

The automated ordering method of assigning a value score to each of the product and/or the service may be based on a weighted criteria. The weighted criteria may include cost, quality, compliance with corporate policies, and/or employee feedback. The method may dynamically adjust weights and/or scores in response to changing conditions and/or corporate priorities. The method may prioritize items with the highest value scores by dynamically adjusting weights and/or scores in response to changing conditions and/or corporate priorities. The automated ordering method may automatically procure the item and/or the preferred substitute for the user when the manager associated with the user approves the requisition request.

The automated ordering method may request the user to provide a satisfaction score to the item and/or the preferred substitute when the user receives the item and/or the preferred substitute. The automated ordering method occasionally queries the user to determine if the item and/or the preferred substitute provided to the user may still desire and/or may be placed in an available item in the internal asset reallocation server.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG 1. is a system architecture view of an AI-powered requisition engine designed to streamline the procurement process in a large enterprise, according to one embodiment.

FIG 2. is an employee request workflow illustrating a step-by-step process flow that an employee follows to make a purchase request using the AI-powered requisition engine of FIG. 1, according to one embodiment.

FIG 3. is a schematic diagram of AI recommendation logic that visually breaks down how the AI generates recommendations using the AI-powered requisition engine of FIG. 1, according to one embodiment.

FIG 4. is an automated approval flow diagram to streamline the approval of requests either automatically and/or through the managerial review using the AI-powered requisition engine of FIG. 1, according to one embodiment.

FIG 5. illustrates an employee feedback and asset reallocation loop showcasing how the AI requisition engine of FIG. 1 manages employee feedback and asset reallocation over time, according to one or more embodiments.

FIG 6. illustrates a bar graph showing the difference impacting on business productivity before and after the AI requisition engine implementation of FIG. 1, according to one embodiment.

FIG 7. illustrates a narrative-driven example showing how an employee, named Alice, experiences the benefits of the new AI-powered system implemented by the AI requisition engine of FIG. 1, according to one embodiment.

FIG 8. is a process flow diagram detailing the operations involved in automatically generating a recommendation of a preferred substitute of an item associated with a requisition request of a user by the AI-driven requisition system of FIG. 1, according to one embodiment.

FIG 9. is another process flow diagram detailing the operations involved in automatically approving the automated quote for a service and/or a product associated with a requisition request of a user by the AI-driven requisition system of FIG. 1, according to one embodiment.

Other features of the present embodiments will be apparent from the accompanying drawings and from the detailed description that follows.

### DETAILED DESCRIPTION

Example embodiments, as described below, may be used to provide a method, apparatus and system of artificial intelligence-driven requisition optimization to streamline procurement and resource reallocation.

In one embodiment, a method includes identifying an item 142 associated with a requisition request (e.g., employee requisition request 112) of a user (e.g., an employee 114) using a processor and a memory. The method determines whether the user is permitted to request item 142 based on a set of permissions assigned to the user. The method automatically suggests a preferred substitute (e.g., using approved vendor list 126 of the cloud-based vendor database 122) to the item 142 based on an artificial intelligence optimization engine (e.g., using AI-driven requisition system 102) that prioritizes a criteria including any of an availability, a price, a vendor 144, and/or a recommendation score (e.g., using AI recommendation 124 of the AI-driven requisition system 102).

The method may include processing a natural language string of the requisition request using a large language model (e.g., using large language processing 116 of the AI-driven requisition system 102). The method includes determining the item 142 based on an inference generated by a fine tuned version of the large language model that may be optimized based on requisition phraseology when the natural language string is automatically provided in a context window analyzed by the fine tuned version of the large language model. The method may determine the item 142 and/or the preferred substitute is described as available in an internal asset reallocation server. The method may automatically suggest (e.g., product recommendation 202 of the AI-driven requisition system 102) to the user to select the item 142 and/or the preferred substitute that is available in the internal asset reallocation server 140.

The method may automatically generate a recommendation (e.g., product recommendation 202 of the AI-driven requisition system 102) to a manager to approve (e.g., using approval requests 136 of the of the AI-driven requisition system 102) the requisition request using the artificial intelligence optimization engine. The method may include automatically procuring the item 142 and/or the preferred substitute (e.g., using product delivery 128) for the user when the manager associated with the user approves the requisition request. The method may include requesting that the user provide a satisfaction score (e.g., using a feedback rating 504) to the item 142 and/or the preferred substitute when the user receives the item 142 and/or the preferred substitute. The method may further include occasionally querying the user to determine if the item 142 and/or the preferred substitute provided to the user may still desire and/or may be placed in an available item 142 in the internal asset reallocation server 140.

In another embodiment, a system (e.g., using AI-driven requisition system 102) includes identifying an item 142 that is associated with a requisition request (e.g. an employee requisition request 112) of a user (e.g. an employee 114) using a processor and a memory, determining whether the user is permitted to request the item 142 based on a set of permissions assigned to the user, processing a natural language string of the requisition request using a large language model (e.g., using large language processing 116 of the AI-driven requisition system 102), and determining the item 142 based on an inference generated by a fine tuned version of the large language model that is optimized based on requisition phraseology when the natural language string is automatically provided in a context window analyzed by the fine tuned version of the large language model.

The system may automatically suggest a preferred substitute (e.g., using approved vendor list 126 of the cloud-based vendor database 122) to the item 142 based on an artificial intelligence optimization engine that prioritizes a criteria including any of an availability, a price, a vendor 144, and/or a recommendation score (e.g., using AI recommendation 124 of the AI-driven requisition system 102). The system may determine that the item 142 and/or the preferred substitute is described as available in an internal asset reallocation server 140. The system may automatically suggest to the user to select the item 142 and/or the preferred substitute that is available in the internal asset reallocation server 140. The system may automatically generate a recommendation to a manager 132 to approve the requisition request using the artificial intelligence optimization engine. The system may automatically procure the item 142 and/or the preferred substitute for the user when the manager associated with the user approves the requisition request (e.g., using manager review and approval 206). The system may request that the user provide a satisfaction score (e.g., using a feedback rating 504) to the item 142 and/or the preferred substitute when the user receives the item 142 and/or the preferred substitute. The system may occasionally query the user to determine if the item 142 and/or the preferred substitute provided to the user is still desired and/or may be placed in an available item 142 in the internal asset reallocation server 140.

In yet another embodiment, an automated ordering method includes enabling a user (e.g., an employee 114) to describe their needs in natural language via a communication medium (e.g., a slack message 106, an email 108, a webportal 110, etc.) including an audio input, a video input, and/or a syntax input. The method includes selecting a product and/or a service from an organized database (e.g., using a cloud-based vendor database 122 of the AI-driven requisition system 102) based on an inference generated by a fine tuned version of a large language model that is optimized based on requisition phraseology when the description of needs (e.g. an employee requisition request 112) in natural language is automatically provided in a context window analyzed by the fine tuned version of the large language model (e.g., using large language processing 116 of the AI-driven requisition system 102). The method further includes generating an automated quote (e.g., using submit request 204) for the product and/or the service. In addition, the method includes approving the automated quote and/or sending an order for the product and/or the service to a vendor 144.

The automated ordering method may provide direct links to recommend the product and/or the service based on cost (e.g., using cost optimization 308), quality (e.g., review analysis 310), compliance with corporate policies (e.g., using vendor compliance check 306), and/or employee feedback (e.g., using feedback collection 130 of the AI-driven requisition system 102). The method may include prioritizing the product and/or service that delivers the best value.

The automated ordering method of assigning a value score (e.g., using AI analyzes reviews and ratings 314 of the AI-driven requisition system 102) to each of the product and/or the service may be based on a weighted criteria. The weighted criteria may include cost, quality, compliance with corporate policies, and/or employee feedback. The method may dynamically adjust weights and/or scores in response to changing conditions and/or corporate priorities. The method may prioritize item 142 with the highest value scores by dynamically adjusting weights and/or scores in response to changing conditions and/or corporate priorities. The automated ordering method may automatically procure (e.g., product delivery 128) the item 142 and/or the preferred substitute for the user when the manager 132 associated with the user approves (e.g., using manage review and approval 206) the requisition request.

The automated ordering method may request the user (e.g., an employee 114) to provide a satisfaction score (e.g., using giving feedback rating 504 of the AI-driven requisition system 102) to the item 142 and/or the preferred substitute (e.g., using approved vendor list 126 of the cloud-based vendor database 122) when the user receives the item 142 and/or the preferred substitute. The automated ordering method occasionally queries (e.g., using reallocate to other employee? 508 of the AI-driven requisition system 102) the user to determine if the item 142 and/or the preferred substitute provided to the user may still desire and/or may be placed in an available item 142 in the internal asset reallocation server 140.

The newly developed software may be an innovative solution that transforms the procurement process within large enterprises by harnessing the power of artificial intelligence, according to at least one embodiment. This AI-driven requisition system 102 may be designed to streamline how the employees request 112 and receive the products and services they need for their work, which may ultimately save the corporation money and enhancing overall operational efficiency, according to at least one embodiment.

In a typical large organization, the process of requesting necessary equipment and/or services may be cumbersome and/or time-consuming, according to at least one embodiment. The employees 114 may often have to navigate complex procurement procedures, fill out detailed forms, and/or wait for approvals from multiple levels of management. This traditional approach may not only hamper productivity but also increase the likelihood of errors and/or delays, according to at least one embodiment.

The AI-driven requisition system 102 may address these challenges by integrating natural language processing 116 and advanced machine learning algorithms into the company's existing communication platforms, including but not limited to a slack message 106 and/or an email 108, according to at least one embodiment. When the employee 114 needs a particular item 142 and/or service, they may simply describe what they're looking for in plain language. For instance, the employee 114 may send a message saying, “I need a new ergonomic keyboard for better wrist support”, according to at least one embodiment.

The AI-driven requisition system 102 may interpret this natural language input, understanding the employee's 114 intent and the specifics of their request, according to at least one embodiment. The AI-driven requisition system 102 may then automatically provide a link to a dedicated requisition portal 104 where the employee 114 may view a curated selection of keyboards that match their needs. These options may sourced from an approved vendor list 126 of corporate-approved vendors 144 to ensure compliance with company procurement policies, according to at least one embodiment.

One of the key features of this software is its ability to optimize costs, according to at least one embodiment. The AI-driven requisition system 102 may search for the lowest-priced items 142 that may meet the employee's 114 requirements, comparing prices across the approved vendor list 126, according to at least one embodiment. The AI searches may ensure that the company gets the best possible deal without sacrificing the quality and/or functionality of the product and services, according to at least one embodiment. Additionally, the AI-driven requisition system 102 may organize product choices based on reviews from other the employees 114 who may made similar purchases. These peer reviews may be displayed on the employee interface 104, giving the employee 114 valuable insights into the performance and/or satisfaction levels associated with each option, according to at least one embodiment.

After the employee 114 selects an item 142 and/or submits the requisition, the AI-driven requisition system 102 may automatically route the approval request to the appropriate manager 132, according to at least one embodiment. The AI-driven requisition system 102 may determine the right approver by referencing the organization's reporting hierarchy and/or org chart, according to at least one embodiment. The AI-driven requisition system 102 may enhance the approval workflow by providing the manager 132 with key indicators to inform their decision. This may include the employee's requisition 112 history, an analysis of how the requested item 142 aligns with their job responsibilities, and an assessment of the potential impact on business productivity, according to at least one embodiment. The AI-driven requisition system 102 may even make a recommendation on whether the manager 132 should approve the employee requisition request 112 which may support its suggestion with data-driven insights, according to at least one embodiment.

Once the item 142 is approved and delivered, the AI-driven requisition system 102 may continue to engage with the employee 114. The AI-driven requisition system 102 may automatically send prompts asking for feedback rating 504 on the product and/or service received, according to at least one embodiment. The employee's 114 feedback rating 504 may be crucial as it feeds back into the AI-driven requisition system 102, refining future recommendations and influencing the referral scores of products and vendors 144, according to at least one embodiment. If the employee 114 expresses dissatisfaction or encounters issues requiring technical support, the AI-driven requisition system 102 may detect this through sentiment analysis. Negative experiences may be noted and affect the referral scores, which may ensure that future recommendations steer other employees 114 towards more reliable options, according to at least one embodiment.

Moreover, the AI-driven requisition system 102 periodically checks in with the employees 114 to assess their ongoing satisfaction with the purchased assets, according to at least one embodiment. The AI-driven requisition system 102 may ask whether they are still using the item 142 and, if not, whether they may be willing (e.g., reallocate to other employee? 508) to have it reallocated to a colleague, according to at least one embodiment. This feature may promote the efficient use of company resources by identifying underutilized assets and facilitating their redistribution within the organization, according to at least one embodiment. For employees 114 seeking similar items 142, the AI-driven requisition system 102 may suggest these available resources, which may reduce the need for new purchases and further cutting costs, according to at least one embodiment.

The AI-driven requisition system 102 may be continually enhanced through machine learning, according to at least one embodiment. The AI-driven requisition system 102 may update its knowledge base with each interaction, incorporating the latest data and feedback to improve its recommendations, according to at least one embodiment. The AI-driven requisition system 102 may perform inferences based on the most recent context and may ensure that it adapts to changing the employee 114 needs and market conditions, according to at least one embodiment. This continuous improvement cycle may make the AI-driven requisition system 102 more accurate and effective over time, according to at least one embodiment.

Integration with existing corporate systems may be seamless, according to at least one embodiment. The AI-driven requisition system 102 may connect with the company's enterprise resource planning (ERP) and inventory management systems, providing real-time data on product availability and pricing, according to at least one embodiment. This integration may ensure that all procurement activities are aligned with the company's policies and financial controls, maintaining compliance and governance standards, according to at least one embodiment.

Security and privacy may be fundamental to the AI-driven requisition system 102 design. Robust security protocols may protect sensitive data, and role-based access controls ensure that only authorized personnel may view or approve requisitions, according to at least one embodiment. The AI-driven requisition system 102 may comply with data protection regulations, giving the employees 114 and the managers 132 confidence in its use, according to at least one embodiment.

The benefits of this AI-driven requisition system 102 may be multifaceted, according to at least one embodiment. For the corporation, it may lead to significant cost savings 604 by minimizing unnecessary expenditures and promoting the efficient use of existing assets. By streamlining the requisition and approval processes, the AI-driven requisition system 102 may reduce administrative overhead and accelerate the delivery of necessary tools and services to the employees 114, thereby enhancing productivity, according to at least one embodiment.

The managers 132 may benefit from data-rich insights that support informed decision-making, according to at least one embodiment. The managers 132 may approve or deny requests with a clear understanding of the implications for their teams and the broader organization, according to at least one embodiment. The AI-driven requisition system 102 recommendations 124 may help align procurement decisions with strategic objectives and company policies, according to at least one embodiment.

The employees 114 may enjoy a simplified and user-friendly experience, according to at least one embodiment. The ability to request items 142 using natural language in familiar communication tools may reduce frustration and save time, according to at least one embodiment. Access to peer reviews may help the employees 114 make better choices, and the prompt feedback loops ensure their voices are heard, contributing to continuous improvement, according to at least one embodiment.

From an environmental and sustainability perspective, the AI-driven requisition system 102 may promote the reuse and reallocation of resources, according to at least one embodiment. By identifying underused assets and facilitating their transfer to where they're needed, the company may reduce waste and minimizes its environmental footprint, according to at least one embodiment.

Looking ahead, the AI-driven requisition system 102 may have the potential for further enhancements, according to at least one embodiment. Predictive analytics 138 may enable the AI-driven requisition system 102 to anticipate future needs based on project plans or seasonal trends, allowing for proactive procurement strategies. Advanced reporting tools may provide deeper insights into spending patterns and opportunities for bulk purchasing and/or vendor 144 negotiations, according to at least one embodiment. For multinational corporations, the AI-driven requisition system 102 may be expanded to incorporate global vendor management, accommodating different currencies, languages, and regional compliance requirements, according to at least one embodiment.

In conclusion, this AI-driven requisition system 102 may represent a significant advancement in corporate procurement, according to at least one embodiment. By integrating artificial intelligence into the fabric of everyday communication and workflows, the AI-driven requisition system 102 may transform a traditionally complex process into a seamless and intelligent system, according to at least one embodiment. The AI-driven requisition system 102 may not only save money but also enhance productivity, support informed decision-making, and contribute to the employee 114 satisfaction, according to at least one embodiment. The AI-driven requisition system 102 may align individual needs with organizational goals, fostering a culture of efficiency, responsiveness, and continuous improvement. This innovative solution may position companies to be more agile and competitive in a rapidly evolving business landscape, according to at least one embodiment.

### Gamification Elements

Introducing gamification into the AI-driven requisition system 102 may significantly boost the employee 114 engagement and make the procurement process more enjoyable, according to at least one embodiment. By incorporating elements including but not limited to points, badges, and leaderboards, the employees 114 are incentivized to participate actively. For example, the employee 114 may earn points for cost-saving decisions, timely feedback submissions, or opting for reallocated assets (e.g., using reallocate to other employee 510) instead of new purchases, according to at least one embodiment. Accumulated points may be redeemed for rewards including but not limited to gift cards, extra vacation days, or public recognition within the company. This approach may not only motivate the employees 114 to make fiscally responsible choices but also foster a sense of community and healthy competition, according to at least one embodiment.

### Virtual Assistant Integration

Integrating a virtual assistant within the AI-driven requisition system 102 may greatly enhance user experience, according to at least one embodiment. This AI-powered chatbot may guide employees through the procurement process, answer questions in real-time, and provide personalized recommendations based on the employee's 114 past requisitions and preferences, according to at least one embodiment. For instance, if the employee 114 frequently orders ergonomic office equipment, the virtual assistant may proactively suggest the latest ergonomic products. The assistant may also help troubleshoot issues, reducing the need for additional support staff, according to at least one embodiment.

### Augmented Reality (AR) Previews

Incorporating augmented reality technology may allow the employees 114 to visualize products in their actual work environment before making a request, according to at least one embodiment. For example, using a smartphone or tablet camera, the employee 114 may see how a new piece of furniture would fit in their office space or how a piece of equipment may integrate with existing machinery, according to at least one embodiment. This feature may help the employees 114 make more informed decisions, reduce the likelihood of returns or dissatisfaction, and add an innovative and interactive dimension to the procurement process, according to at least one embodiment.

### Predictive Needs Assessment

The AI-driven requisition system 102 may be enhanced to predict future requisition needs by analyzing project timelines, departmental objectives, and historical purchasing data, according to at least one embodiment. For instance, if a department typically orders additional laptops during a particular season due to increased workloads, the AI-driven requisition system 102 may anticipate this need and notify the managers 132 in advance, according to at least one embodiment. This proactive approach may allow for better budget planning, bulk purchasing discounts, and ensures that the employees 114 have necessary resources when they need them, according to at least one embodiment.

### Social Collaboration Features

Creating a social platform within the AI-driven requisition system 102 may encourage the employees 114 to share their experiences, recommendations, and tips regarding various products and services, according to at least one embodiment. This peer-to-peer interaction may include discussion forums, Q&A sections, and the ability to follow colleagues with similar roles or interests. Such features may promote knowledge sharing and may lead to more informed purchasing decisions, as the employees 114 benefit from the collective wisdom of their peers, according to at least one embodiment.

### Sustainability Tracking

The AI-driven requisition system 102 may highlight the environmental impact of procurement choices by displaying information including but not limited to the carbon footprint of products, the sustainability practices of vendors 144, and the availability of eco-friendly alternatives, according to at least one embodiment. For example, when selecting office supplies, the AI-driven requisition system 102 may indicate which products are made from recycled materials or are certified by environmental organizations. By tracking and reporting on these metrics, the company may align its procurement activities with corporate social responsibility goals and promote environmentally conscious decision-making among the employees 114, according to at least one embodiment.

### Integration With Project Management Tools

By integrating the AI-driven requisition system 102 with project management software, the AI-driven requisition system 102 may automatically identify and suggest items 142 needed for upcoming projects, according to at least one embodiment. For instance, if a project plan indicates the need for specialized software or equipment, the AI-driven requisition system 102 may prompt the project manager or team members to initiate a requisition, according to at least one embodiment. This may ensure that all necessary resources are accounted for in advance, reducing delays and enhancing project efficiency, according to at least one embodiment.

Blockchain for Secure Transactions

Implementing blockchain technology may add an extra layer of security and transparency to the procurement process, according to at least one embodiment. Each transaction may be recorded on an immutable ledger, providing a clear and tamper-proof audit trail. This may be particularly beneficial for compliance and regulatory purposes, as it may ensure that all procurement activities are documented and verifiable, according to at least one embodiment. Additionally, blockchain may streamline vendor 144 payments and contract management by automating these processes through smart contracts, according to at least one embodiment.

### Vendor Performance Dashboard

Developing a real-time dashboard 134 that displays analytics on vendor performance may empower procurement teams and the managers 132 to make better-informed decisions, according to at least one embodiment. The dashboard 134 may include metrics including but not limited to delivery times, product quality ratings, the frequency of service issues, and overall employee satisfaction with vendor products, according to at least one embodiment. This visibility may allow the company to assess vendor reliability, negotiate better terms, and potentially phase out underperforming vendors 144 in favor of those who consistently meet or exceed expectations, according to at least one embodiment.

### Customized Onboarding Kits

For the new employees 114, the AI-driven requisition system 102 system may automatically generate a personalized list of recommended tools, equipment, and resources based on their role and departmental needs, according to at least one embodiment. This may streamline the onboarding process by ensuring that new hires may possess all the necessary products and services from day one, according to at least one embodiment. For example, a new graphic designer may receive a suggested kit that may include a high-performance computer, design software subscriptions, and a graphics tablet. This may not only improve the onboarding experience but also accelerate the new employee's 114 productivity, according to at least one embodiment.

### Mobile Application Access

Creating a mobile app version of the AI-driven requisition system 102 may enhance accessibility, and may allow the employees 114 and the managers 132 to make requests, approve items 142, and provide feedback anytime and anywhere, according to at least one embodiment. The mobile app may send a push notifications 502 for approval requests, feedback reminders, or updates on the status of requisitions. This flexibility may ensure that critical procurement activities are not delayed due to the unavailability of key personnel, according to at least one embodiment.

### AI-Powered Negotiation

Leveraging AI-driven requisition system 102 to negotiate with vendors 144 may lead to cost savings 604 and better procurement terms, according to at least one embodiment. The AI-driven requisition system 102 may analyze historical pricing data, market trends, and the company's purchasing volumes to identify opportunities for discounts or favorable conditions, according to at least one embodiment. For example, if the AI-driven requisition system 102 may detects that the company frequently purchases a particular type of equipment, it may negotiate bulk pricing or extended warranties with the vendor 144, according to at least one embodiment. This automated negotiation may be conducted in real-time, streamlining the procurement process and reducing the workload on procurement staff, according to at least one embodiment.

Employee Wellness Integration

The AI-driven requisition system 102 may support the employee 114 wellness initiatives by suggesting products and services that promote health and well-being, according to at least one embodiment. For instance, the AI-driven requisition system 102 may recommend standing desks, ergonomic chairs, or mindfulness app subscriptions to the employees 114 who may express interest or whose roles involve prolonged periods of sitting, according to at least one embodiment. By aligning procurement with wellness programs, the company may enhance an employee satisfaction 606 and productivity while demonstrating a commitment to their well-being, according to at least one embodiment.

### Voice Command Functionality

Integrating voice command capabilities may allow the employees 114 to interact with the AI-driven requisition system 102 using virtual assistants like Amazon Alexa, Google Assistant, or Apple's Siri. The employees 114 may initiate requests, ask for status updates, or receive recommendations through voice commands, according to at least one embodiment. For example, the employee 114 may say, “Hey Siri, request a new headset for video conferencing.” This hands-free interaction may add convenience and may be particularly useful for the employees 114 who are multitasking or have accessibility needs, according to at least one embodiment.

### Multi-Language Support

Implementing multi-language support may ensure that the AI-driven requisition system 102 may be accessible and user-friendly for a diverse, global workforce, according to at least one embodiment. The employees 114 may interact with the AI-driven requisition system 102 in their preferred language, which may improve comprehension and reduce errors in the requisition process, according to at least one embodiment. This inclusivity may promote equal access to resources and may overall enhance the employee satisfaction 606, according to at least one embodiment.

### Anomaly Detection for Fraud Prevention

The AI-driven requisition system 102 may be equipped with algorithms that may detect unusual requisition patterns indicative of potential fraud or misuse, according to at least one embodiment. For example, if the employee 114 suddenly requests high-value items 142 that are unrelated to their role, the AI-driven requisition system 102 may flag this behavior for review. Early detection may help protect the company from financial losses and ensure compliance with internal policies and external regulations, according to at least one embodiment.

### Personalized Ai Profiles

Developing personalized AI profiles for each of the employee 114 may allow the AI-driven requisition system 102 to learn their preferences, habits, and needs over time, according to at least one embodiment. The AI-driven requisition system 102 may then provide increasingly tailored recommendations and streamline the requisition process. For instance, if the employee 114 consistently prefers eco-friendly products, the AI-driven requisition system 102 may prioritize suggesting sustainable options. This personalization may enhance the user experience and may lead to higher satisfaction rates, according to at least one embodiment.

### Budget Tracking and Alerts

The AI-driven requisition system 102 may include real-time budget tracking features for departments and projects, according to at least one embodiment. The managers 132 may have visibility into current spending levels and receive alerts when approaching predefined budget limits. This transparency may encourage more mindful spending and help prevent budget overruns. Additionally, the AI-driven requisition system 102 may suggest cost-saving alternatives or recommend deferring non-essential purchases when budgets are tight, according to at least one embodiment.

### Interactive Tutorials and Support

Incorporating interactive tutorials, FAQs, and support chatbots within the AI-driven requisition system 102 may assist the employees 114 in navigating the platform and resolving common issues, according to at least one embodiment. New users may benefit from guided tours that explain how to make requests, track approvals, and provide feedback. Accessible support resources may reduce frustration, decrease reliance on help desks, and contribute to a smoother user experience, according to at least one embodiment.

### Integration With External Marketplaces

While adhering to corporate procurement policies, the AI-driven requisition system 102 may be expanded to include a wider range of products and services from external marketplaces, according to at least one embodiment. This integration may allow the AI-driven requisition system 102 to find better deals or unique items 142 that may not be available through standard vendors 144, according to at least one embodiment. For example, if the employee 114 requires a specialized piece of equipment not offered by approved vendors 144, the AI-driven requisition system 102 may facilitate the purchase while ensuring compliance through appropriate approvals and documentation, according to at least one embodiment.

### Employee Surveys for Continuous Improvement

Regularly surveying the employees 114 about their experiences with the AI-driven requisition system 102 may provide valuable insights for ongoing enhancements, according to at least one embodiment. The surveys may ask about ease of use, satisfaction with recommendations, or suggestions for new features. By acting on this feedback, the company may demonstrate a commitment to meeting the employee 114 needs and may continuously refine the AI-driven requisition system 102 to improve its effectiveness, according to at least one embodiment.

### Automated Compliance Checks

Embedding compliance rules within the AI-driven requisition system 102 may ensure that all requisitions adhere to company policies and regulatory requirements, according to at least one embodiment. The AI-driven requisition system 102 may automatically flag or prevent requests that may violate spending limits, contractual obligations, or legal regulations, according to at least one embodiment. For instance, if the employee 114 attempts to request a product from an unapproved vendor 144, the AI-driven requisition system 102 may alert them and provide alternative options. This automation may reduce the risk of non-compliance and streamline the approval process, according to at least one embodiment.

### Dynamic Approval Thresholds

Adjusting approval workflows based on the cost or category of the item 142 may expedite the procurement process, according to at least one embodiment. Low-cost or routine items 142 may be automatically approved without managerial intervention, while higher-cost or non-standard items 142 may require additional scrutiny. For example, office supplies under a certain dollar amount may bypass approvals and may ensure the employees 114 receive necessary items 142 quickly while the managers 132 may focus on more significant expenditures, according to at least one embodiment.

### Sponsorship and Partnership Opportunities

Exploring partnerships with vendors 144 may lead to exclusive deals, discounts, or sponsorships that may benefit both the company and the employees 114, according to at least one embodiment. For instance, a technology vendor 144 may offer the company early access to new products or special pricing in exchange for feedback or case studies. These partnerships may enhance the value derived from procurement activities and foster mutually beneficial relationships, according to at least one embodiment.

### Emergency Procurement Protocols

Implementing protocols for emergency procurement may ensure that critical needs are addressed promptly, according to at least one embodiment. The AI-driven requisition system 102 may determine the urgency of requests based on predefined criteria, including but not limited to equipment failures that may halt production and/or urgent safety concerns, according to at least one embodiment. In such cases, the AI-driven requisition system 102 may expedite approvals, notify relevant stakeholders immediately, and prioritize the fulfillment of these requisitions to minimize operational disruptions, according to at least one embodiment.

By integrating these creative ideas into the AI-driven requisition system 102, the company may significantly enhance its procurement process, according to at least one embodiment. These enhancements may not only improve efficiency and cost-effectiveness but also enrich the user experience, promote sustainability, and strengthen compliance. Ultimately, these innovations may contribute to a more agile and responsive organization that is well-equipped to meet the evolving needs of its employees 114 and the market, according to at least one embodiment.

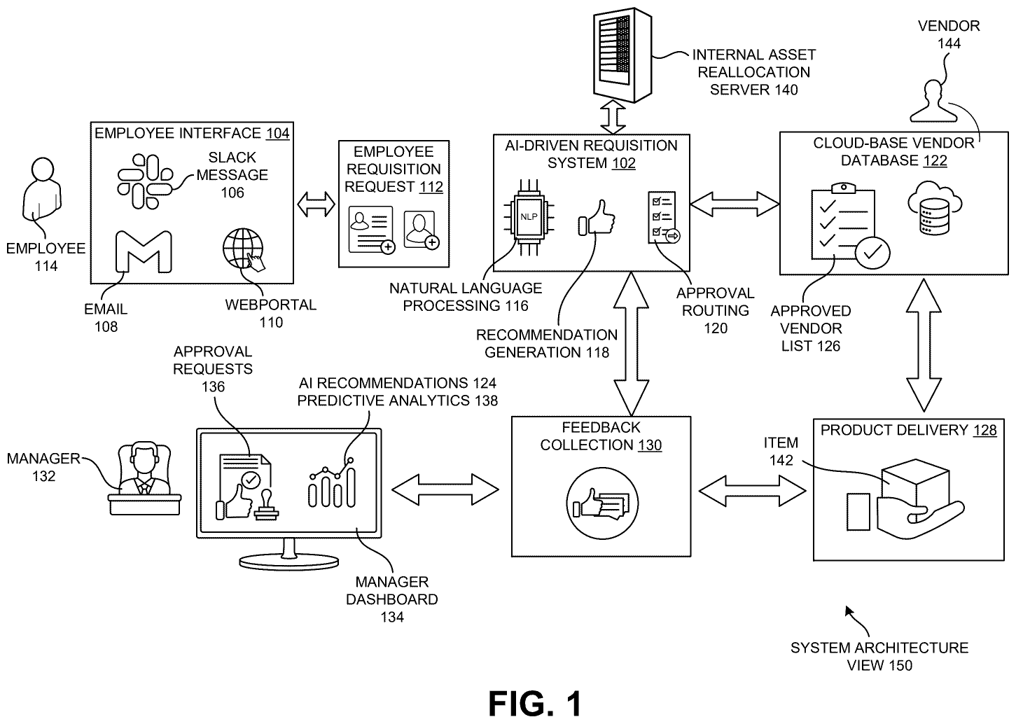

FIG. 1 is a system architecture view 150 of an AI-driven requisition system 102 designed to streamline the procurement process in a large enterprise, according to one embodiment.

The AI-driven requisition system 102 may be an advanced software system specifically designed to automate and/or enhance the procurement process within an organization using Artificial Intelligence (AI). The AI-driven requisition system 102 may primarily function to streamline how requests for goods and/or services may processed, evaluated, and/or fulfilled. The AI-driven requisition system 102 may automate, including but not limited to the intake, processing, and/or routing of purchase requests to the appropriate channels, which may reduce the need for manual intervention and/or speed up the procurement cycle, according to at least one embodiment.

The AI-driven requisition system 102 may utilize AI technologies, including but not limited to machine learning and/or natural language processing 116. The AI-driven requisition system 102 may understand and/or interpret the specifics of each requisition including but not limited to identifying the required products, services, quantities, and/or urgency, according to at least one embodiment.

By analyzing historical data, the AI-driven requisition system 102 may provide recommendations for vendor 144 selection, pricing strategies, and/or optimal purchasing options that may help organizations make informed decisions that align with the financial and/or operational goals, according to at least one embodiment.

The natural language processing 116 may allow the system to read and/or understand the text in requisitions as humans would and may enable the text to classify and/or extract relevant information automatically, according to at least one embodiment.

The machine learning models may be used for prediction and/or recommendation tasks. For example, the machine learning models may predict the best vendors 144 based on past performance and/or recommend bulk purchasing if the analysis shows the machine learning models may save costs, according to at least one embodiment.

The AI-driven requisition system 102 may use approval routing algorithms to determine the necessary approvals for each request based on predefined rules including but not limited to cost of the requisition, the department making the request, and/or specific compliance requirements. Approval routing 120 may determine the necessary approvals needed based on the type and scope of the request, according to at least one embodiment.

The AI-driven requisition system 102 may integrate with other enterprise systems (like ERP, CRM, or Vendor Management Systems) for a seamless flow of information and/or processes. This integration may allow the AI-driven requisition system 102 to fetch data from other enterprise systems to improve the accuracy of its recommendations and/or to post updates back to the AI-driven requisition system 102 to keep all organizational data in sync, according to at least one embodiment.

The AI-driven requisition system 102 may reduce processing times and eliminate bottlenecks in the procurement process. The AI-driven requisition system 102 may ensure cost-effectiveness by recommending the best vendors 144 and negotiating better terms based on predictive analytics 138. The AI-driven requisition system 102 may maintain compliance with organizational spending policies and may provide a transparent audit trail of all procurement activities, according to at least one embodiment.

According to one embodiment, the AI-driven requisition system 102 may quickly adapt to changing organizational needs and/or market conditions by learning from new data and adjusting the algorithms of the AI-driven requisition system 102 accordingly.

Overall, the AI-driven requisition system 102 may transform the traditional procurement process into a more dynamic, efficient, and/or intelligent system and may allow organizations to leverage technology to meet procurement needs more effectively, according to at least one embodiment. The AI-driven requisition system 102 may be designed to enhance the efficiency of the procurement process by including but not limited to automating the routing, approval, and/or vendor 144 selection processes, which may ensure that employees 114 may quickly and/or easily procure the goods and services the employees 114 may need while maintaining compliance with company policies and/or budgets, according to at least one embodiment.

The cloud-based vendor database 122 may be a central component of the AI-powered requisition system, closely integrated with the AI-driven requisition system 102 to facilitate an efficient, scalable, and/or dynamic procurement process for the organization, according to at least one embodiment. The cloud-based vendor database 122 may be hosted on a cloud-based computing network, which may ensure high availability, scalability, and/or security of data. The cloud database may allow for real-time data access and/or updates, which may be crucial for maintaining an up-to-date repository of vendor 144 information, according to at least one embodiment.

The approved vendor list 126 may be a curated list within the cloud database that may include vendors 144 who meet the organization's standards for quality, reliability, and/or cost-effectiveness. The approved vendor list 126 may be dynamically updated based on ongoing assessments and/or feedback, according to at least one embodiment. The cloud-based vendor database 122 may maintain an approved vendor list 126 which the AI-driven requisition system 102 may use to make recommendations, according to at least one embodiment.

When the AI-driven requisition system 102 processes a new employee requisition request 112, the AI-driven requisition system 102 may query the cloud-based vendor database 122 to retrieve relevant information about vendors 144, according to at least one embodiment. This relevant information may include historical performance data, pricing, delivery times, ratings, and/or compliance status, according to at least one embodiment.

The recommendation generation 118 may be a process of enhancing the procurement process by using data-driven insights to suggest including but not limited to the most suitable vendors 144, products, and/or services for each requisition, according to at least one embodiment. The recommendation generation 118 may leverage a combination of machine learning, data analytics, and/or historical performance metrics to provide tailored recommendations that align with the organization's operational and/or financial goals. Utilizing the data fetched from the cloud-based vendor database 122, the AI-driven requisition system 102 may apply algorithms to analyze and select the best vendors 144 for the specific needs mentioned in the AI-driven requisition system 102. This decision may be based on various criteria including but not limited to cost-effectiveness, vendor 144 reliability, past experiences, and/or any specific preferences and/or constraints specified by the organization, according to at least one embodiment.

The AI-driven requisition system 102 may aggregate and/or integrate data from various sources, including but not limited to cloud-based vendor database 122, past purchasing records, inventory levels, and/or external market trends, according to at least one embodiment. This comprehensive dataset may form the basis for generating accurate and/or relevant recommendations, according to at least one embodiment.

The AI-driven requisition system 102 may use smart machine learning models to analyze past data and/or find patterns and may assist in suggesting the best vendors 144, products, and/or services for each request, according to at least one embodiment. The AI-driven requisition system 102 may use classification algorithms to match products, and/or services with the right vendors 144, regression models to predict costs and/or delivery times, and/or clustering techniques to group similar requests, according to at least one embodiment. By using predictive analytics 138, the AI-driven requisition system 102 may also forecast trends including but not limited to price changes and/or vendor 144 reliability. This helps the manager 132 to make better decisions, secure good deals, and/or anticipate any potential supply chain issues, according to at least one embodiment.

The AI-driven requisition system 102 may personalize recommendations based on the specific needs and past preferences of the department and/or individual making the requisition, according to at least one embodiment. For example, if a department frequently orders a particular type of office supply and may comprise a preferred vendor 144 based on past satisfaction and/or performance, the AI-driven requisition system 102 may prioritize this vendor 144 in the recommendations, according to at least one embodiment.

The optimization algorithms may used to determine the best combination of products and vendors 144, considering multiple objectives including but not limited to minimizing cost, reducing delivery time, and/or maximizing vendor 144 performance ratings, according to at least one embodiment.

The AI-driven requisition system 102 may analyze the requisition details using natural language processing 116 to extract relevant information, including but not limited to product specifications, required quantities, and/or desired delivery schedules, according to at least one embodiment.

Using the extracted details, the AI-driven requisition system 102 may query the integrated database to find matching vendors 144 and/or products that may meet the specified criteria, according to at least one embodiment. Vendors 144 and products may evaluated based on a scoring system that may consider factors including but not limited to as price competitiveness, quality ratings, delivery performance, and/or compliance with corporate policies. The AI-driven requisition system 102 may then rank the options to present the best choices to the requester, according to at least one embodiment.

Post-procurement feedback may be collected using the feedback collection module 130 and may analyzed to continuously refine and/or improve the recommendation algorithms, according to at least one embodiment. The feedback collection module 130 may help the AI learn from real-world outcomes and may adjust predictive models accordingly. The AI-driven requisition system 102 may collect feedback on vendor 144 performance and/or overall satisfaction with the procured goods and/or services using the feedback collection module 130, according to at least one embodiment. The feedback collection module 130 may be used to update the vendor 144 profiles in the cloud-based vendor database 122, affecting their ratings and/or status on the approved vendor list 126. The cloud infrastructure may facilitate the dynamic updating of the cloud-based vendor database 122 as new information becomes available, according to at least one embodiment. This may include updates from vendors 144 themselves, changes in the market, and/or internal adjustments based on organization and/or company policies, according to at least one embodiment.

The AI-driven requisition system 102 may come up with various benefits including but not limited to efficiency cost-effectiveness, enhanced vendor 144 relationships, and/or improved decision-making, according to at least one embodiment.

The natural language processing 116 (NLP) techniques may also utilize vendor-related data to better understand and/or classify the requisitions. For example, matching keywords in requisitions to services offered by vendors 144 in the cloud-based vendor database 122, according to at least one embodiment.

The cloud-based vendor database 122 may allow the AI-driven requisition system 102 to easily scale up and/or down based on the organization's needs. As the number of requisitions and/or vendors 144 grows, the cloud database may accommodate the growth without a loss in performance, according to at least one embodiment.

This integrated approach, where the cloud-based vendor database 122 may be closely linked with the AI-driven requisition system 102, not only streamlines the procurement process but also enhances decision-making capabilities with accurate, comprehensive, and up-to-date information, thereby driving efficiency and reducing operational costs for large organizations, according to at least one embodiment.

The manager dashboard 134 may be used by the managers 134 to oversee and approve requisition requests. The manager dashboard 134 may display the AI-generated recommendations 124 and the predictive analytics 138 on requisitions including but not limited to approval statuses, spending patterns, and/or vendor 144 performance, according to at least one embodiment.

Approval requests 136 may be requests that require managerial approval, which may be monitored and/or managed by the manager 134 through the manager dashboard 134, according to at least one embodiment. Once the recommendation is approved by the manager 134, the procurement is done by the AI-driven requisition system 102 for product delivery 128, according to at least one embodiment. The AI-driven requisition system 102 may manage the logistics of delivering approved products and/or services from vendors 144 to the enterprise through product delivery 128. Once the product delivery 128 is complete, the feedback collection module 130 may prompt the purchasing employee for feedback on the product's quality, usefulness, and fit for their needs. The feedback is then integrated into the AI-driven requisition system 102 for continuous learning, according to one embodiment.

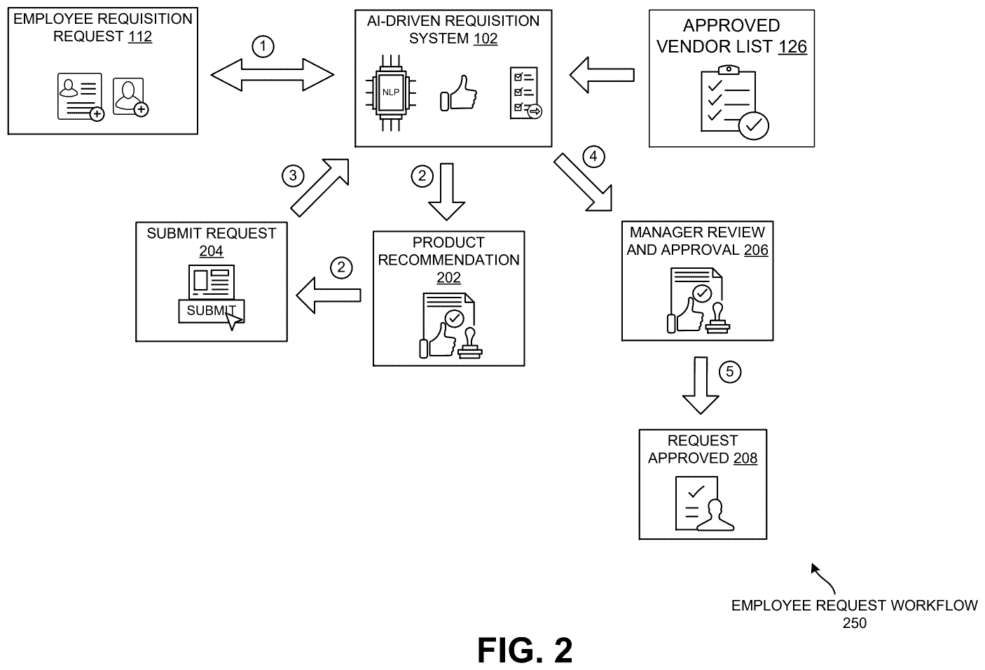

FIG. 2 is an employee request workflow 250 illustrating a step-by-step process flow that an employee follows to make a purchase request, according to one embodiment.

In step 1, the employee 114 may initiate a request by typing a natural language message, such as “Need a new ergonomic chair,” on the employee interface 114 using a platform including but not limited to the slack message 106, the email 108, and/or the web portal 110, according to one embodiment.

In step 2, the AI-driven requisition system 102 may process and interpret the employee request 122 using the natural language processing (NLP) 116. The AI-driven requisition system 102 may search and generate a list of product recommendations 202 from the approved vendor list 126, according to one embodiment.

In step 3, the AI-driven requisition system 102 may display the list of product recommendations 202 from the approved vendor list 126 based on the employee requisition request 112, according to one embodiment.

In step 4, the employee 114 may review the product recommendations 202, select a suitable product, and submit the request 204, according to one embodiment.

In step 5, the request may automatically be routed to the manager review and approval 206. The manager 132 may evaluate the product recommendations 202 provided by the AI-driven requisition system 102 and may decide whether to approve and/or deny the request, according to one embodiment.

In step 6, once the manager 132 approves the request, the order may be placed and confirmed, which may complete the procurement process, according to one or more embodiment.

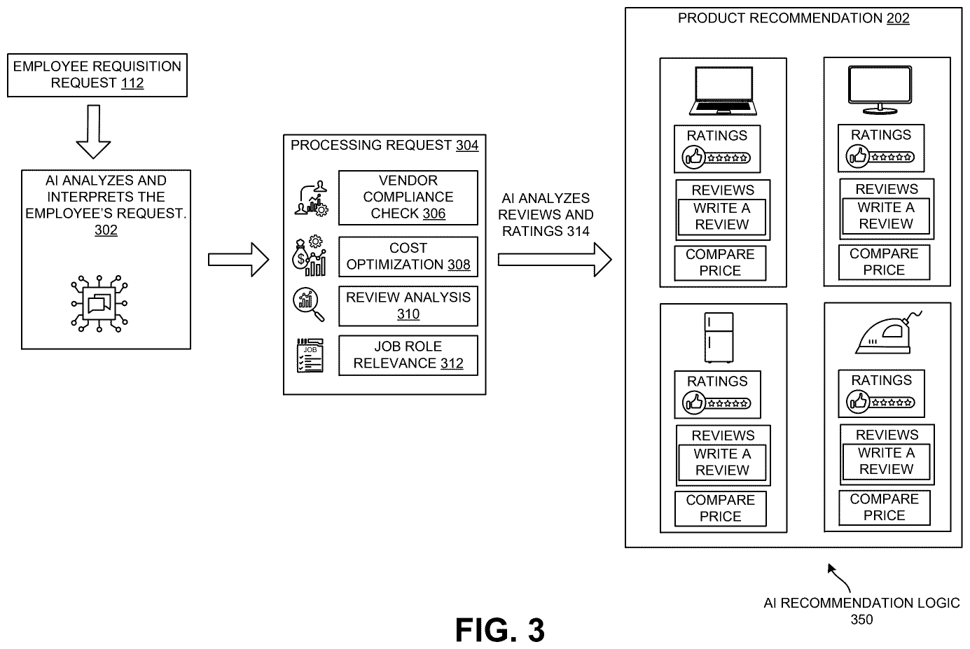

FIG. 3 is a schematic diagram of AI recommendation logic 350 that visually breaks down how the AI generates recommendations, according to one embodiment.

The AI-driven requisition system 102 may receive input from the employee 114 from the employee interface 104. The AI-driven requisition system 102 may generate product recommendations 202 based on an employee requisition request 112, according to at least one embodiment.

The employee 114 may type in a simple natural language request, e.g., “I need a new laptop,” which the AI-driven requisition system 102 interprets. After inputting the request, the AI may analyze and interpret 302 and may understand the request using natural language processing 116. The AI analyzes and interprets 302 may be critical as it helps the AI-driven requisition system 102 break down what specific product the employee 114 needs, which may set the stage for more targeted recommendations, according to at least one embodiment.

Once the AI-driven requisition system 102 understands the request from the employee 114, the request may move into a detailed processing phase, according to at least one embodiment. According to one embodiment, the AI-driven requisition system 102 may run the employee requisition request 112 through various filters to ensure the AI-driven requisition system 102 may suggest the best options. According to at least one embodiment, the processing request 304 may include:
Vendor Compliance Check 306: This may ensure that the products come from vendors 144 approved by the organization. This step may be important for ensuring compliance with organization policies and/or contracts.
Cost Optimization 308: The AI-driven requisition system 102 may look for the most budget-friendly options without compromising quality. The AI-driven requisition system 102 may ensure that the product recommendation 202 is cost-effective.
Review Analysis 310: To guarantee quality, the AI-driven requisition system 102 may check the reviews and ratings of the product from other users to recommend only well-reviewed products.
Job Role Relevance 312: The AI-driven requisition system 102 may customize the product recommendation 202 based on the specific job role of the employee 114 and may recommend tools that are appropriate and/or relevant to work of the employee 114 needs.

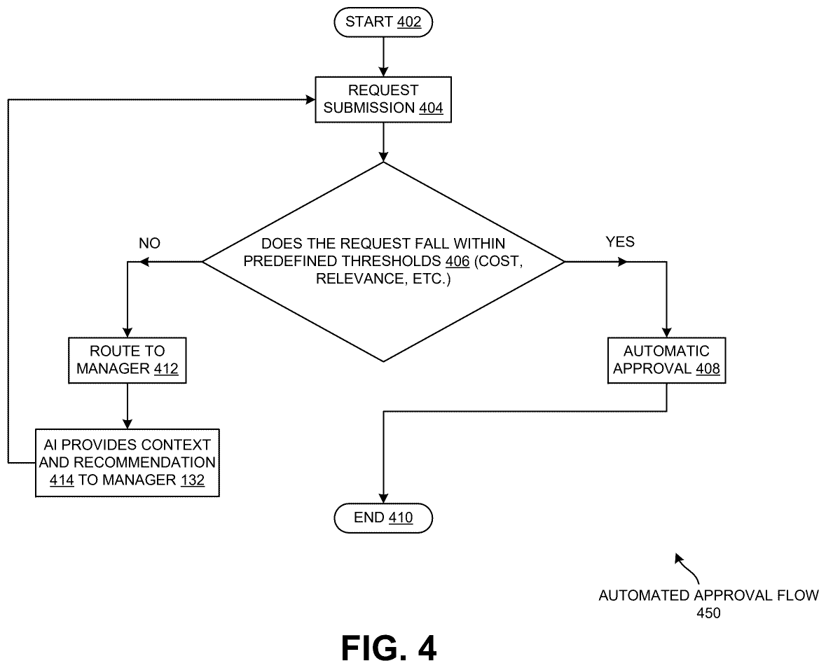

FIG. 4 is an automated approval flow 450 diagram to streamline the approval of requests either automatically and/or through the managerial review, according to one embodiment.

The process may begin at start 402 when the request is submitted (e.g., request submission 404) initiated by the employee 114, according to at least one embodiment.

After the request submission 404, the request enters a decision point where the AI-driven requisition system 102 may check if the request falls within predefined thresholds 406. The predefined thresholds 406 may be the factors including but not limited to, cost limits, relevance to the employee's 114 role, and other organizational guidelines, according to at least one embodiment.

If the employee requisition request 112 meets (“Yes”) the predefined thresholds 406, the AI-driven requisition system 102 may move to automatic approval 408. In this case, the employee requisition request 112 may be approved without requiring further review by the manager 132, and the process may proceed to completion at the end 410, according to at least one embodiment.

If the employee requisition request 112 may not (“No”) meet the predefined thresholds 406, the AI-driven requisition system 102 may route the employee requisition request 112 to the manager for manual review (Route to Manager 412), according to at least one embodiment.

Once routed to the manager (Route to Manager 412), the AI-driven requisition system 102 may assist by providing additional context and/or recommendations to assist in decision-making (AI provides context and recommendation 414). This may help the manager 132 quickly understand why the request was flagged and/or what action might be appropriate, according to at least one embodiment.

The process may conclude at end 410 after the manager 132 either approves and/or denies the employee requisition request 112 with feedback provided to the employee 114, according to at least one embodiment.

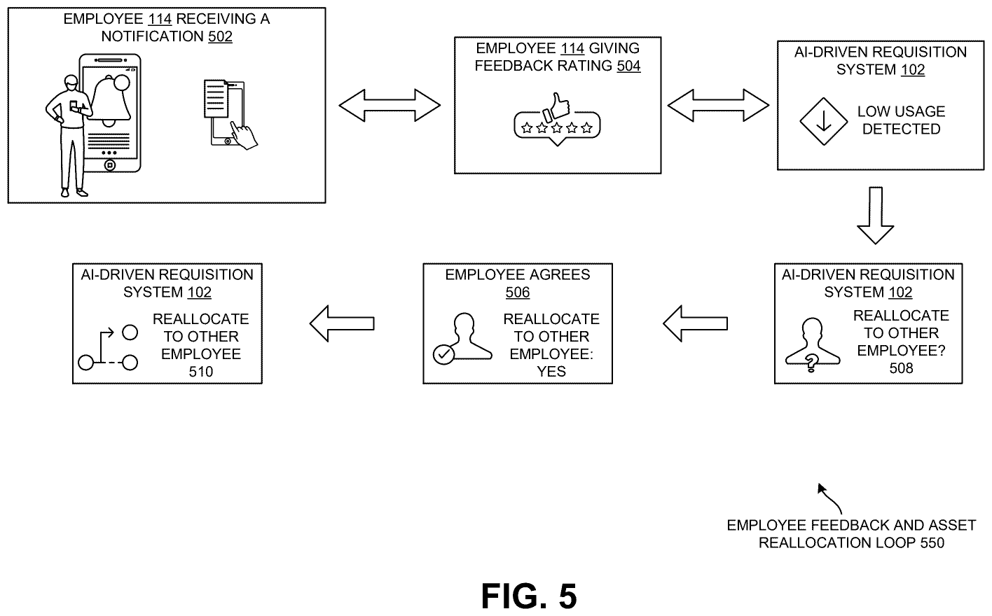

FIG. 5 illustrates an employee feedback and asset reallocation loop 550 showcasing how the AI-driven requisition system 102 manages employee feedback and asset reallocation over time, according to one or more embodiments.

When employee 114 receives a notification 502 on the mobile device, and is asked the employee 114 to provide feedback on a newly assigned asset, including but not limited to a laptop. This notification 502 may prompt the employee 114 to rate satisfaction with the products, according to at least one embodiment.

After receiving the notification 502, the employee 114 provides a feedback rating 504. In this case, the employee 114 may give a positive rating by assigning five stars to the asset. This feedback rating 504 may help track the initial reception and/or satisfaction with the assigned asset, according to at least one embodiment.

After some time, the AI-driven requisition system 102 may monitor the usage patterns of the asset, according to at least one embodiment. If the pattern detects low usage, the AI-driven requisition system 102 may initiate a reallocation process. The AI-driven requisition system 102 may then ask the employee 114 whether the employee 114 may be willing to reallocate the asset to another employee 114, according to at least one embodiment.

If the employee 114 agrees to reallocate the asset, the employee 114 may confirm the decision, which may allow the AI-driven requisition system 102 to proceed with the reallocation process, according to at least one embodiment. The AI-driven requisition system 102 may then find another employee 114 who may benefit from using the asset to ensure the benefits continue to be fully utilized, according to at least one embodiment. Thus, the AI-driven requisition system 102 may intelligently reallocate the organizational resources for optimal utilization, according to one embodiment.

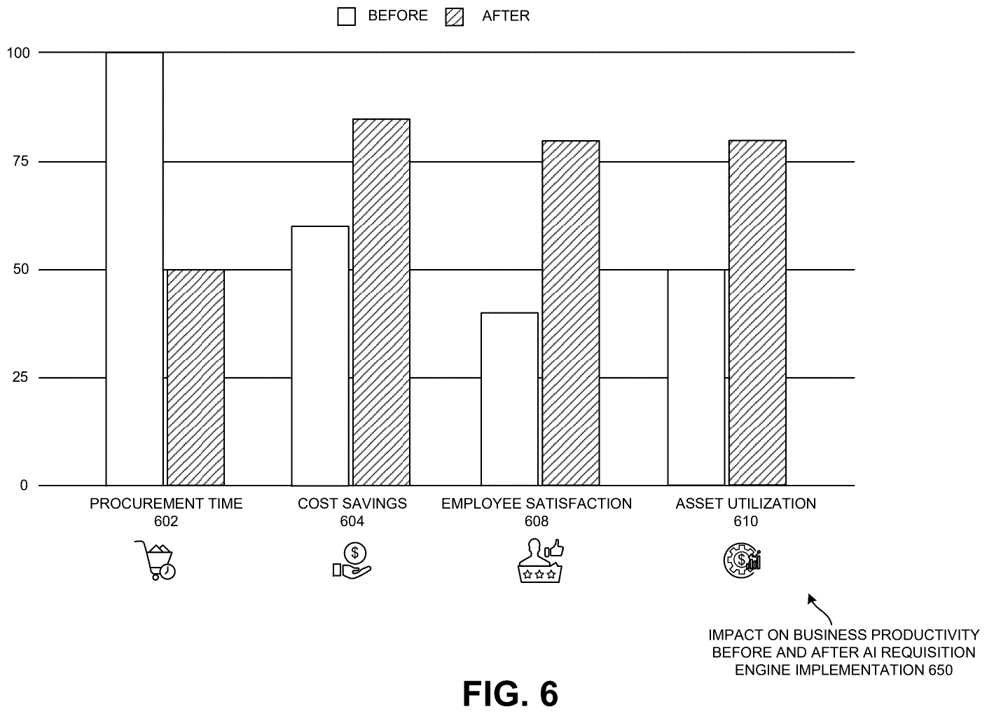

FIG. 6 illustrates a bar graph showing the difference impacting business productivity before and after AI-driven requisition system 102 implementation 650, according to one embodiment.

The bar graph illustrates that a procurement time 602 (the time it takes to get products and services after making a request) is decreased a lot after using the AI-driven requisition system 102, according to at least one embodiment. Before the AI-driven requisition system 102, the procurement time 602 may take much longer time to get products and services, which is shown by the tall bar. After the implementation of the requisition engine 102, the procurement time 602 is reduced, and may take a much shorter time to get products and services, which is shown by the shorter bar, according to at least one embodiment.

The bar graph further illustrates an increase in cost savings 604 after implementing the AI-driven requisition system 102, according to at least one embodiment. The tall bar shows the scenario after the implementation of the AI-driven requisition system 102, which may indicate that the organization and/or company saved more money as compared to before, which may be shown by the shorter bar, according to at least one embodiment.

The bar graph further illustrates that employee satisfaction 606 has improved indicating that the employee 114 is more satisfied with the procurement process after the implementation of the AI-driven requisition system 102, which may be shown by the tall bar, according to at least one embodiment. Before the AI-driven requisition system 102 (shown by shorter bar), the employee 114 may faced delays and/or difficulties in getting the products and services the employee 114 needed, which may lead to frustration, according to at least one embodiment. The AI-driven requisition system 102 may make the procurement process quicker and/or easier improving the employee satisfaction 606, according to at least one embodiment.

Before implementation of the AI-driven requisition system 102 (which may be shown by the shorter bar), asset utilization 608 was low, which may be because the company resources including but not limited to equipment and/or tools may not be used effectively, according to at least one embodiment. The employee 114 may often find and/or access the company resources difficult, which may lead to underutilized items 142 and/or inefficiency and may make the asset utilization 608 difficult for the employee 114 to complete the tasks since the equipment and/or tools the employee 114 needed are not always readily available, according to at least one embodiment. After the implementation of the AI-driven requisition system 102, the asset utilization 608 may be improved significantly. The AI-driven requisition system 102 may help track and/or reallocate assets, which may ensure that more company resources are being actively used and that the employee 114 may get access to what the employee 114 needs, according to at least one embodiment. This may reduce waste and/or make the overall workflow more efficient, which may be shown by the tall bar indicating improved asset utilization 608, according to one embodiment.

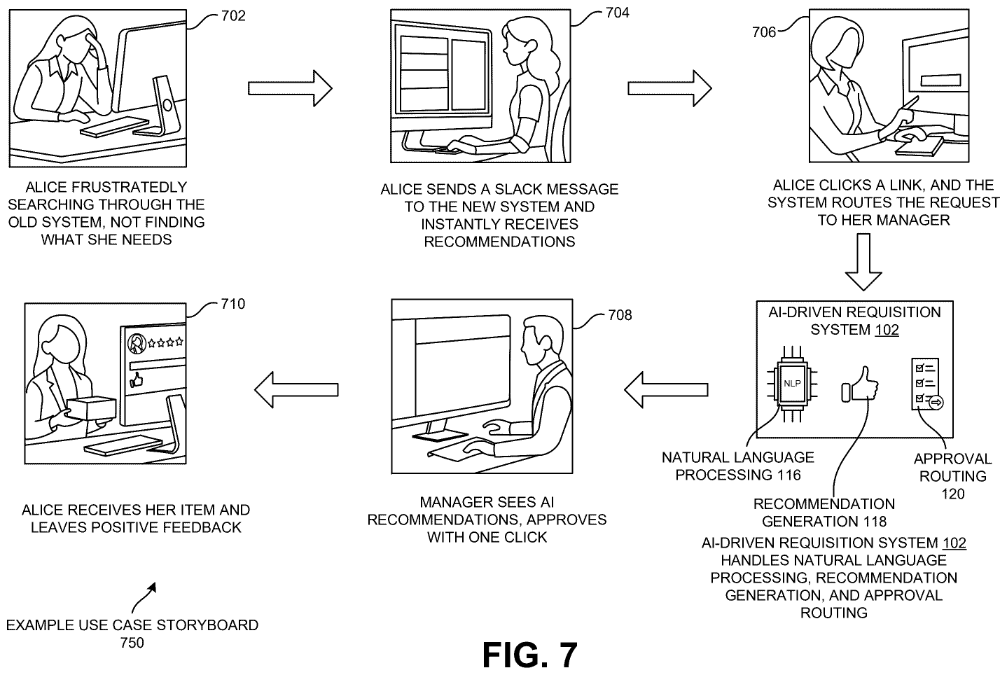

FIG. 7 illustrates a narrative-driven example 750 showing how an employee, named Alice, experiences the benefits of the new AI-powered system implemented by the AI-driven requisition system 102 of FIG. 1, according to one embodiment.

In 702, before the implementation of AI-driven requisition system, Alice may be feeling frustrated because she may be trying to use the old procurement system to find something she needs, but the old procurement system may not be easy to use. The old procurement system may make it difficult for her to locate the product and/or services she is looking for. Alice may be spending a lot of time searching without success, which may make the process very inefficient and leave Alice feeling frustrated and stuck, according to at least one embodiment.

In 704, Alice may interact with the new AI-powered system using the AI-driven requisition system 102 by sending a simple message through slack. The AI-driven requisition system 102 may instantly respond by providing recommendations that may be tailored to her specific request. The entire process shows how the new AI-driven requisition system may be faster and easier to use compared to older methods, which may make the whole process more efficient and/or user-friendly for employees like Alice, according to at least one embodiment.

In 706, Alice may click on a link provided by the AI-driven requisition system 102, which may automatically route her request to her manager for approval. The new AI-driven requisition system 102 may streamline the approval process, and make the approval process faster and easier by reducing manual steps. Instead of manually contacting the manager and/or filling out complicated forms, Alice's request may be forwarded instantly to the manager, which may save time and/or ensure a smoother process, according to at least one embodiment.

In 708, the manager may view the AI-generated recommendations 124 and may approve Alice's request with just one click. This shows how the AI-driven requisition system 102 may provide a simplified and/or efficient interface for the managers, and make it easier for the managers to review and/or approve the employee requests without going through complicated steps. The AI-driven requisition system 102 may help speed up approvals, which may allow the managers to make decisions quickly and/or efficiently, according to at least one embodiment.

In 710, Alice may receive the products and/or services she requested and may leave positive feedback, which may showcase her satisfaction with how smoothly the procurement process worked. The entire experience may be easy and/or efficient for Alice, making the outcome likely that she feels content with the new system compared to the old one, according to at least one embodiment.

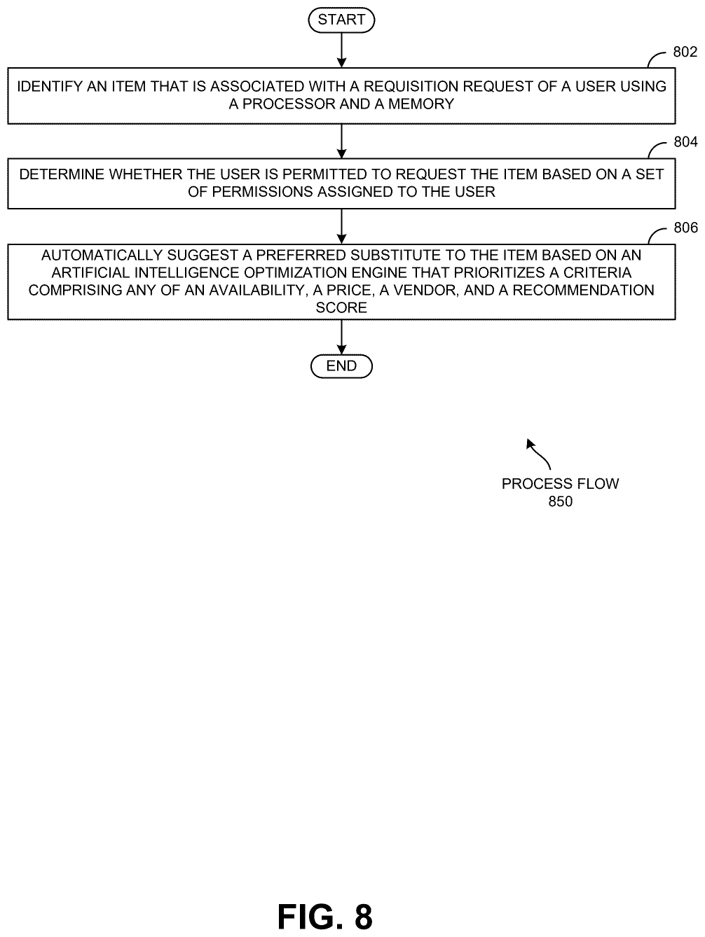

FIG. 8 is a process flow 850 diagram detailing the operations involved in automatically generating an AI recommendation 124 of a preferred substitute of an item 142 associated with a requisition request of a user by the AI-driven requisition system of FIG. 1, according to one embodiment. In operation 802, an item 142 associated with a requisition request of a user may be identified using a processor and a memory. In operation 804, determining whether the user may be permitted to request the item 142 based on a set of permissions assigned to the user. In operation 806, an artificial intelligence optimization engine may automatically suggest a preferred substitute for the item 142 based on criteria comprising any of an availability, a price, a vendor, and a recommendation score.

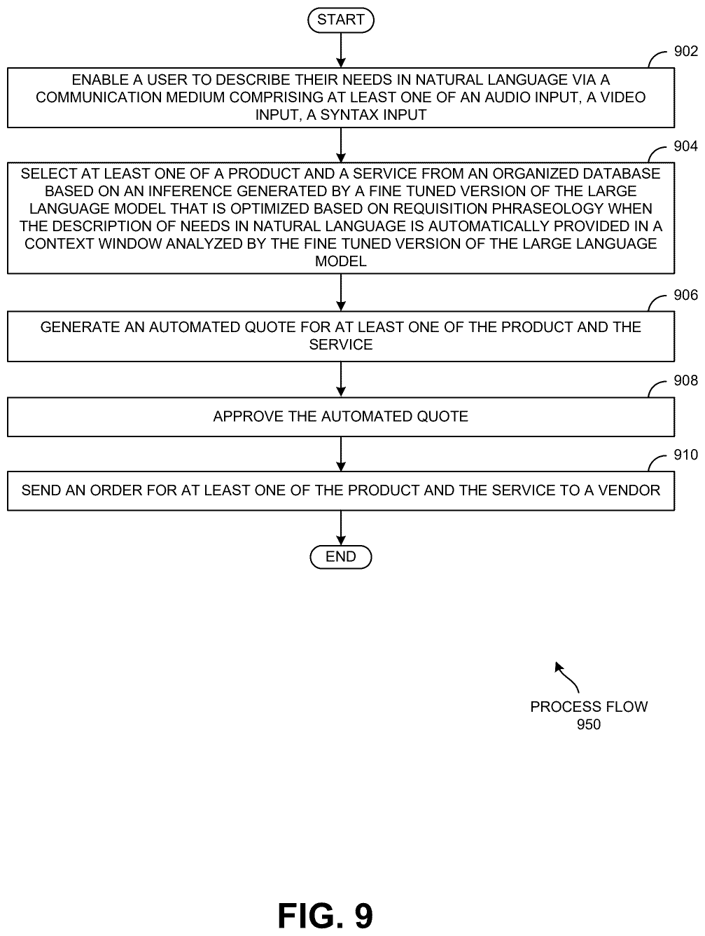

FIG. 9 is another process flow 950 diagram detailing the operations involved in automatically approving the automated quote for a service and/or a product associated with a requisition request of a user by the AI-driven requisition system of FIG. 1, according to one embodiment. In operation 902, a user may describe their needs in natural language via a communication medium comprising at least one of an audio input, video input, or syntax input. In operation 904, selecting at least one of a product and a service from an organized database based on an inference generated by a fine tuned version of a large language model that is optimized based on requisition phraseology when the description of needs in natural language is automatically provided in a context window analyzed by the fine tuned version of the large language model. In operation 906, an automated quote for the product and the service may be generated. In operation 908, the automated quote may be approved. In operation 910, an order for at least one of the product and the service may be sent to a vendor 144, according to one embodiment.

### Real-World Example: How the AI-Powered Requisition System 102 Transforms Procurement at “TechNova Corp”

TechNova Corp, a large technology company with thousands of employees spread across multiple global offices, was facing significant challenges with its procurement process. The employees may often spend hours sifting through an outdated procurement portal, struggling to find the right equipment and supplies they may need for their projects. Compliance with approved vendor 144 lists may be low, and costs may be spiraling out of control due to non-standard purchases and a lack of centralized oversight, according to at least one embodiment.

John, a senior software engineer, may need a new high-performance laptop for a project with tight deadlines. Frustrated with the convoluted procurement process, he may send an email to his manager asking for a recommendation. The manager 132, equally unsure about the options and prices, may forward the request to the procurement team, leading to a lengthy back-and-forth. Weeks passed, and John may still not have the equipment he needed, delaying his project and costing the company time and money, according to at least one embodiment.

Meanwhile, in another department, Sarah, a marketing executive, may order a high-end camera for a campaign. After using it for a few weeks, she may realized it wasn't suitable for her needs. But there was no efficient way to return or reallocate the camera, which may ended up gathering dust in her office. Enter the AI-driven requisition system 102. TechNova may implement the software to overhaul its entire procurement process, according to at least one embodiment. John may now simply type a message into the company's Slack channel: “Need a new laptop for heavy coding work, any recommendations?” Within seconds, the AI may respond with a curated list of high-performance laptops from approved vendors 144, highlighting the best options based on reviews from other engineers at TechNova who may have purchased similar models. The AI may display cost comparisons and may suggest the most budget-friendly option, according to at least one embodiment.

Once John selects a laptop, the system may automatically route the request to his manager for approval. The AI may provide a recommendation, stating, “John has requested a high-performance laptop essential for his role in the upcoming project, according to at least one embodiment. The selected model has been rated highly by other software engineers and falls within the budget range. Approval is recommended.” The manager, equipped with this data, may approve the request with a single click, and the order may be processed immediately, according to at least one embodiment.

After receiving the laptop, the AI may follow up with John, asking for his feedback. John may rate the laptop five stars, mentioning that it significantly improved his productivity. This feedback may be stored in the system, enhancing future recommendations for similar roles, according to at least one embodiment. Meanwhile, Sarah may receive a notification from the AI: “We noticed you haven't used the camera recently. Would you be willing to reallocate it to a colleague?” Sarah, who may no longer need the camera, agreed. The AI may then suggest the camera to another employee in the design team who may be about to request a similar item 142, according to at least one embodiment. The employee may gladly accept the reallocation, saving the company the cost of purchasing a new camera, according to at least one embodiment.

Over the next few months, TechNova may see a marked reduction in procurement costs, according to at least one embodiment. Employees 114 may be making smarter choices with the AI's guidance, and asset utilization may be improved significantly, according to at least one embodiment. Managers 132 may appreciate the automated, data-driven recommendations that may streamline the approval process, freeing them to focus on more strategic tasks, according to at least one embodiment.

With the AI-driven requisition system 102, TechNova may transform its procurement process from a frustrating bottleneck into a streamlined, cost-effective, and employee-friendly system, according to at least one embodiment. Employees 114 like John may get what they need faster, Sarah's unused assets may be efficiently reallocated, and the company may save both time and money, according to at least one embodiment. The AI-driven insights and automation may make the procurement process smarter, more efficient, and more aligned with TechNova's business goals, ultimately boosting productivity and employee satisfaction across the board, according to at least one embodiment.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., data processing device 100). Accordingly, the specification and drawings are to be regarded in an illustrative rather than a restrictive sense.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A method comprising:
identifying an item that is associated with a requisition request of a user using a processor and a memory;
determining whether the user is permitted to request the item based on a set of permissions assigned to the user; and
automatically suggesting a preferred substitute to the item based on an artificial intelligence optimization engine that prioritizes a criteria comprising any of an availability, a price, a vendor, and a recommendation score.

2. The method of claim 1 further comprising:
processing a natural language string of the requisition request using a large language model; and
determining the item based on an inference generated by a fine tuned version of the large language model that is optimized based on requisition phraseology when the natural language string is automatically provided in a context window analyzed by the fine tuned version of the large language model.

3. The method of claim 1 further comprising:
determining that at least one of the item and the preferred substitute is described as available in an internal asset reallocation server; and
automatically suggesting to the user to select at least one of the item and the preferred substitute that is available in the internal asset reallocation server.

4. The method of claim 1 further comprising:
automatically generating a recommendation to a manager to approve the requisition request using the artificial intelligence optimization engine.

5. The method of claim 4 further comprising:
automatically procuring at least one of the item and the preferred substitute for the user when the manager associated with the user approves the requisition request.

6. The method of claim 5 further comprising:
requesting that the user provide a satisfaction score to at least one of the item and the preferred substitute when the user receives at least one of the item and the preferred substitute.

7. The method of claim 1 further comprising:
occasionally querying the user to determine if at least one of the item and the preferred substitute provided to the user is still desired or should be placed in an available item in the internal asset reallocation server.

8. A system comprising:
identifying an item that is associated with a requisition request of a user using a processor and a memory;
determining whether the user is permitted to request the item based on a set of permissions assigned to the user;
processing a natural language string of the requisition request using a large language model; and
determining the item based on an inference generated by a fine tuned version of the large language model that is optimized based on requisition phraseology when the natural language string is automatically provided in a context window analyzed by the fine tuned version of the large language model.

9. The system of claim 8 further comprising:
automatically suggesting a preferred substitute to the item based on an artificial intelligence optimization engine that prioritizes a criteria comprising any of an availability, a price, a vendor, and a recommendation score.

10. The system of claim 8 further comprising:
determining that at least one of the item and the preferred substitute is described as available in an internal asset reallocation server; and
automatically suggesting to the user to select at least one of the item and the preferred substitute that is available in the internal asset reallocation server.

11. The system of claim 8 further comprising:
automatically generating a recommendation to a manager to approve the requisition request using the artificial intelligence optimization engine.

12. The system of claim 11 further comprising:
automatically procuring at least one of the item and the preferred substitute for the user when the manager associated with the user approves the requisition request.

13. The system of claim 12 further comprising:
requesting that the user provide a satisfaction score to at least one of the item and the preferred substitute when the user receives at least one of the item and the preferred substitute.

14. The system of claim 9 further comprising:
occasionally querying the user to determine if at least one of the item and the preferred substitute provided to the user is still desired or should be placed in an available item in the internal asset reallocation server.

15. An automated ordering method, comprising:
enabling a user to describe their needs in natural language via a communication medium comprising at least one of an audio input, a video input, a syntax input;
selecting at least one of a product and a service from an organized database based on an inference generated by a fine tuned version of a large language model that is optimized based on requisition phraseology when the description of needs in natural language is automatically provided in a context window analyzed by the fine tuned version of the large language model;
generating an automated quote for at least one of the product and the service;
approving the automated quote; and
sending an order for at least one of the product and the service to a vendor.

16. The automated ordering method of claim 15 wherein:
providing direct links to a recommended one at least one of the product and the service based on at least one of cost, quality, compliance with corporate policies, and employee feedback; and
prioritizing at least one of the product and the service that offers a best value.

17. The automated ordering method of claim 15 wherein:
assigning a value score to each of the product and the service based on a weighted criteria, wherein the weighted criteria comprises at least one of cost, quality, compliance with corporate policies, and employee feedback;
dynamically adjusting weights and scores in response to changing conditions and corporate priorities; and
prioritizing items with a highest value scores by dynamically adjusting weights and scores in response to changing conditions and corporate priorities.

18. The automated ordering method of claim 15 further comprising:
automatically procuring at least one of the item and the preferred substitute for the user when the manager associated with the user approves the requisition request.

19. The automated ordering method of claim 18 further comprising:
requesting that the user provide a satisfaction score to at least one of the item and the preferred substitute when the user receives at least one of the item and the preferred substitute.

20. The automated ordering method of claim 15 further comprising:
occasionally querying the user to determine if at least one of the item and the preferred substitute provided to the user is still desired or should be placed in an available item in the internal asset reallocation server.
